(19) United States
(12) Patent Application Publication
(10) Pub. No.: US 2026/0308821 A1
(43) Pub. Date: Oct. 8, 2026

(54) METHOD FOR PRODUCING NOBLE METAL MESHES ON FLATBED KNITTING MACHINES

(71) Applicant: HERAEUS PRECIOUS METALS GMBH & CO. KG, Hanau (DE)

(72) Inventors: Pascal HIRSCHEL, Hanau (DE); Verena WALD, Hanau (DE)

(21) Appl. No.: 19/480,256

(22) PCT Filed: May 3, 2024
(86) PCT No.: PCT/EP2024/062191

§ 371 Date: Oct. 30, 2025

(30) Foreign Application Priority Data
May 17, 2023 (EP) 23173800.6

(51) Int. Cl. D04B 1/12; B01J 23/46; B01J 35/58; B01J 37/00; D04B 1/10

(52) U.S. Cl. CPC D04B 1/12; B01J 23/464; B01J 35/58; B01J 37/00; D04B 1/104; D10B 2505/00

(57) ABSTRACT

A method for producing a noble metal mesh on a flatbed knitting machine which comprises at least one needle bed and at least one knitted fabric take-up device which is spaced apart at a distance D from the at least one needle bed. In this method, at least a portion of a support mesh is first knitted over at least the length of the distance between the needle bed and a take-up device of the flatbed knitting machine. In the context of the invention, it was found that knitting a support mesh using a noble-metal-free support thread over a minimum length before starting to knit the noble metal mesh has a stabilizing effect on the knitting process.

The present invention relates to a method for producing a noble metal mesh on a flatbed knitting machine. In this method, at least a portion of a support mesh is first knitted over at least the length of the distance between the needle bed and a take-up device of the flatbed knitting machine.

The heterogeneous noble-metal-catalyzed oxidation of ammonia (NH₃) to nitric acid (HNO₃, Ostwald process) or the production of hydrogen cyanide (HCN, Andrussow process) are of great importance due to the central relevance of the products for the chemical industry. The catalyst systems used for this purpose are typically, in the form of gas-permeable fabrics, incorporated into the reaction zone of a flow reactor in a plane perpendicular to the flow direction of the fresh gas. Collecting or catchment systems for recovering evaporated catalytically active components are also frequently based on such mesh-like structures. Usually, a plurality of meshes are expediently arranged one behind the other and combined to form a catalyst mesh stack. The individual networks consist of fine noble metal wires which predominantly contain platinum (Pt), palladium (Pd), rhodium (Rh) or alloys of these metals. In particular, catchment meshes may also contain further constituents, for example nickel.

A number of methods for producing such meshes as knitted fabric are known, for example weaving, warp-knitting and weft-knitting. Weaving and warp-knitting are particularly suitable for the production of rectangular mesh webs which have a homogeneous material distribution and structure. They offer little flexibility in terms of the shape and material variability of the products to be manufactured.

In comparison, weft-knitting offers greater flexibility: the knitting patterns, wires (in terms of both thickness and material), needles and tension of the wire can be used to vary both the weight per unit area as well as the structure, elasticity and strength of the obtainable knitted fabrics in an uncomplicated manner. Another advantage is the significantly shorter machine set-up times. It is also possible to use different materials in one knitted fabric; in so-called intarsia knitting, for example, different regions are made from different yarns or wires. In principle, the length of a knitted fabric is not limited, but, in the case of flat-bed knitting machines the maximum width is determined by the width of the needle beds.

Flat-bed knitting machines or circular knitting machines can be used for knitting. In circular knitting machines, the needles are arranged in a circular needle bed and the thread or wire is supplied in a circular motion. These machines are primarily used for the production of tubular knitted goods. On flat-bed knitting machines, however, the shape and size of the knitted fabric can be varied. The latter can also comprise more than one needle bed, between which the yarn or wire is guided back and forth during production by means of thread guides.

The use of two needle beds allows a single-layer or two-layer knitted fabric to be produced. In principle, a single-layer knitted fabric can be created in two ways: in one, only one needle bed is worked on, i.e., only stitches are formed on one of the needle beds and knitted together. In the other, stitches formed on the first needle bed can be knitted together with stitches formed on the second needle bed, i.e., the thread is guided back and forth between the two needle beds within a right side and/or wrong side row. Accordingly, a two-layer knitted fabric is created when knitting is carried out simultaneously on both needle beds, and the stitches formed on the first needle row are not connected, or only selectively connected, to the stitches formed on the second needle bed via the edge stitches. With this production method, two single-layer knitted fabrics or layers can thus also be produced simultaneously on the first and second needle bed.

In order to keep the knitted piece taut during production, knitting machines usually have one or more take-up devices arranged below the stitch-formation region of the needle beds. These take-up devices grasp the resulting knitted fabric and apply a pulling force on it.

The knitting of noble metal meshes is known and described for example in EP 0364153 A1. EP 3779005 A1 uses flatbed knitting machines for this purpose. Noble metal meshes with more complex 3-dimensional structures can also be produced in this way, as described, for example, in EP 1358010 A2.

EP 0364153 A1 describes the use of an additional noble-metal-free thread when knitting a noble metal mesh, which increases the process stability. The additional thread is knitted in parallel with the noble metal and can be removed from the produced homogeneous knitted fabric, consisting of noble metal material and thread material, after the knitting process if required. In EP 3779005 A1, this method was developed further to the effect that the additional thread and the noble metal are not knitted in parallel, but simultaneously. This means that noble-metal-free regions can be preserved in the finished knitted fabric, which leads to a reduction in the amount of noble metal used.

However, it has been shown that the knitting of wires containing noble metals poses particular challenges to the knitting process. In particular, it was observed that the mechanical load exerted on the resulting knitted fabric, caused by the direct intermeshing of the noble-metal-containing wire on the needle beds of the flatbed knitting machine, may have a detrimental effect on the production process and quality. Due to the stiffness of the wire, the formed stitches may not be released, leading to a blockage of the noble metal knit on the needles or between the needle beds. This may lead to warping of the knitted fabric and consequently to instabilities in the production process. Such instabilities may manifest themselves in breaks in the wire during the knitting process and also in irregularities with respect to the structure and mechanical properties, both of which can result in a product of poor quality. Such instabilities and the accumulation of stitches and knitted fabric are also detrimental in respect of the load on the needle bed; this can lead to increased damage to the needle bed and to the carriage unit responsible for thread guidance.

The problem addressed by the present invention was therefore to provide a method with high process stability for producing noble metal meshes on flatbed knitting machines using noble-metal-containing wires.

The problem is solved by a method for producing a noble metal mesh on a flatbed knitting machine,

wherein the flatbed knitting machine comprises at least one needle bed and at least one knitted fabric take-up device spaced apart at a distance D from the at least one needle bed, comprising the steps
providing at least one noble-metal-free support thread,
providing at least one noble-metal-containing wire,
knitting a support mesh using the at least one noble-metal-free support thread,
knitting the noble metal mesh using at least one noble-metal-containing wire, characterized in that at least a portion of the support mesh is first knitted over at least the length of the distance D.

In the context of the invention, it was surprisingly found that knitting a support mesh using a noble-metal-free support thread over a minimum length before starting to knit the noble metal mesh has a stabilizing effect on the knitting process. In other words, pre-knitting a support mesh at least over the length of the distance between the needle bed and the take-up device reduces process disturbances in the form of blockages of the resulting noble-metal-containing knitted fabric on the needles or between the needle beds, breaks in the noble-metal-containing wire, or irregularities and defects in the noble metal knitted fabric in the form of faulty rows of stitches and/or connections.

The method according to the invention relates to knitting on a flatbed knitting machine comprising at least one needle bed.

Knitting is characterized by the row-by-row production of the resulting knitted fabric, in which interlocking connections, typically in the form of stitches, are formed. In addition to stitches, depending on the knitting pattern, knitted fabrics may also comprise other connections known to a person skilled in the art in the form of other thread guidance, such as floats or tucks. In the context of this application, stitches are also to be understood as any other possible forms of thread guidance for forming connections. When reference is made in the following to a “thread”, the relevant comment is also intended to apply to a corresponding “wire.” The knitted fabric is formed row by row, in the direction of knitting, with the part of the knitted fabric that contains the first knitting row being referred to in the following as the “bottom.” The thread is guided from one side of the needle bed or needle beds to the other side and back. A knitting row therefore comprises a right side row and a wrong side row, which results from the thread guide. The thread can be guided, in one knitting row, over only one needle bed or, in the case of a knitting machine with two needle beds, over both needle beds. The thread can be guided across the entire width of the needle bed or needle beds, but knitting may also be carried out over only portions of the width of the needle beds. Depending on the width of the needle bed or beds used for knitting, the width and also the shape of the knitted fabric can be determined.

When reference is made in this application to the length of the knitted fabric, this always means the length from the first knitting row to the last knitting row.

During the knitting process on a flatbed knitting machine with a needle bed, the first part of a knitting row is first formed in one direction (right side row), then the thread is guided in the opposite direction (wrong side row).

During the knitting process on a flatbed knitting machine comprising two needle beds, the first portion of a knitting row is first formed on at least one of the needle beds. Typically, the thread for a complete knitting row can first be guided on the first needle bed (right side row), and then the thread is guided in the opposite direction on the same needle bed or the second needle bed (wrong side row). However, the thread can also be guided alternately on both needle beds in a right side and/or wrong side row, with connections being created between stitches on the two needle beds within one knitting row. In this way, a single-layer or two-layer knitted fabric can be formed. In the context of the present invention, “two-layer knitted fabrics” are understood to mean knitted fabrics that comprise two layers, wherein the layers can be interconnected via one or more of their respective abutting edges or can also be unconnected at their abutting edges. The two layers lie on top of each other, i.e., they overlap at least partially in the region of their surface extent. Knitted fabrics that are interconnected on one side via the abutting edges of the two layers are also referred to as two-layer knitted fabrics. A single-layer knitted fabric can be obtained by folding open along the common abutting edge. A combination of single-layer and two-layer regions within a knitted fabric is also possible.

The lower edges are understood to be the edges that are formed first in the knitting direction, i.e., at the bottom in the knitted fabric. Accordingly, the upper edges are understood to be the edges that are formed later in the knitting direction.

A flatbed knitting machine suitable for the method according to the invention has at least one knitted fabric take-up device which is arranged at a distance D from the at least one needle bed.

Knitted fabric take-up devices are known in principle to a person skilled in the art; they may optionally include, for example, one or more rollers, cylinders, belts, hooks, plates, needles or combs. Particularly preferably, the knitted fabric take-up devices of the present invention comprise at least one roller or cylinder. A knitted fabric take-up device may optionally consist of one cylinder or roll or alternatively of two or more rollers or cylinders. If a knitted fabric take-up device according to the invention comprises two rollers or cylinders, these are preferably arranged so that the knitted fabric can be pressed between the rollers or cylinders. The at least two rollers or cylinders can be operated in opposite directions. In this case, the contact pressure between two cylinders or rollers can preferably be adjusted so that the noble metal mesh is sufficiently fixed to exert a pulling force, but is not irreversibly deformed. Knitted fabric take-up devices may be arranged statically or movably under the at least one needle bed. A static knitted fabric take-up device is understood here to mean that the distance between the take-up device and the needle bed remains unchanged during the knitting process. A static knitted fabric take-up device may also include moving parts, such as rollers or cylinders.

The flatbed knitting machine may optionally also be equipped with several knitted fabric take-up devices.

For example, the flatbed knitting machine may have a first knitted fabric take-up device arranged at a distance D from the at least one needle bed and a second knitted fabric take-up device arranged at a distance D2 from the at least one needle bed, wherein D2 is greater than D. In the context of the invention, the value for D is preferably at least 3 cm, in particular at least 2 cm and particularly preferably at least 1 cm, measured from the contact point of the knitted fabric on the needle bed to the point at which the knitted fabric comes into contact with the knitted fabric take-up device.

In the context of the invention, the value for D is preferably at most 20 cm, in particular at most 15 cm and most preferably at most 10 cm, measured from the contact point of the knitted fabric on the needle bed to the point at which the knitted fabric comes into contact with the knitted fabric take-up device. In the specified range for D it can be ensured that the knitted fabric is pressed sufficiently.

The second knitted fabric take-up device is therefore arranged further away from the needle bed than the first knitted fabric take-up device. The distance D2 may preferably be at least 25 cm, in particular at least 30 cm and preferably at least 35 cm, measured from the contact point of the knitted fabric on the needle bed to the point at which the knitted fabric comes into contact with the knitted fabric take-up device. The distance D2 may preferably be at most 100 cm, in particular at most 80 cm and preferably at most 60 cm, measured from the contact point of the knitted fabric on the needle bed to the point at which the knitted fabric comes into contact with the knitted fabric take-up device.

The first and second knitted fabric take-up devices may each be either static or movable. For example, both knitted fabric take-up devices may be static. In preferred embodiments, the flatbed knitting machine has a knitted fabric take-up device which is statically arranged at a distance D2 from the at least one needle bed, and a knitted fabric take-up device which is movably arranged between the at least one needle bed and the statically arranged knitted fabric take-up device. In such cases, the movable knitted fabric take-up device, also referred to as auxiliary take-up device, has a minimum distance D from the at least one needle bed.

The method comprises providing at least one noble-metal-free support thread.

Suitable noble-metal-free support threads can be selected by routine tests, taking into account the final purpose of the noble metal mesh and any additional steps in the manufacturing process. Preferred noble-metal-free support threads can be removed after the production of the noble metal mesh, for example by dissolving in acidic or basic media, cutting, melting or flaming. Such support threads can be of a natural or synthetic organic nature or inorganic nature. Examples of suitable materials are polyamides, polyesters, cellulose fibers, cotton, acrylic-styrene polymers, nylon, PVA and other vinyl polymers, alginate, copper, aluminum, or even metals having a low melting point such as tin alloys and lead alloys.

The at least one noble-metal-free support thread can consist of only one thread-like element; such individual thread-like elements are also referred to as filaments in the case of noble-metal-free threads. The noble-metal-free support thread can also consist of more than one filament, which can advantageously be twisted together. This plurality of filaments may be made of the same or different materials.

The method according to the invention comprises knitting a support mesh using the at least one noble-metal-free support thread.

The term “support mesh” refers to the regions of the knitted fabric that are knitted without using the noble-metal-containing wire. The support mesh is therefore free of noble metals, but can also comprise additional threads or wires.

The knitted fabric comprises all knitting rows that are formed during the method. The knitted fabric comprises at least the support mesh and the noble metal mesh. However, the knitted fabric can also comprise other parts or regions. The shape of the knitted fabric is not otherwise restricted; it may be round, rectangular, or trapezoidal, for example, the shape being determined by the outer edges of the entire knitted fabric. Preferably, all knitting rows of the knitted fabric are knitted over the same width of the needle beds; in other words, the knitted fabric is preferably rectangular.

In the method according to the invention, at least a portion of the support mesh is first knitted over at least the length of the distance D. In other words, before knitting of the noble metal mesh is commenced, knitting is carried out at least over the length D using the noble-metal-free support thread. Preferably, at least 5 knitting rows are knitted using the noble-metal-free support thread. Knitting to a minimum length ensures that the fabric is tensioned by the knitted fabric take-up device, in particular that it is tensioned uniformly, before the more difficult-to-process wire containing noble metals is knitted. It is assumed that this ensures that stitches or knitted portions containing the stiff, noble-metal-containing wire are drawn off the needles during the knitting process. This increases process stability and reduces defects in the noble metal mesh caused by the knitted fabric take-up device.

In the event that the flatbed knitting machine comprises more than one knitted fabric take-up device at different distances from the at least one needle bed, it may be advantageous that at least a portion of the support mesh is first knitted over at least the length of the distance up to at least one knitted fabric take-up device further away than distance D. The more distant knitted fabric take-up device can, for example, be arranged at a distance D2 from the at least one needle bed, D2 being greater than D. In other words, it may be advantageous for at least a portion of the support mesh to be knitted over at least the length D2. In the case where two knitted fabric take-up devices are provided, the first knitted fabric take-up device, located at distance D, can optionally be deactivated once the support mesh reaches the second knitted fabric take-up device, located at distance D2, and the second knitted fabric take-up device can exert a pulling force on the support mesh. This can be particularly advantageous if the first knitted fabric take-up device comprises two rollers or cylinders, in particular counter-rotating rollers or cylinders, with which the knitted fabric can be pressed.

In one possible embodiment, the more distant knitted fabric take-up device, which is arranged at a distance D2, consists only of one roller or cylinder. The use of a single roller or cylinder prevents the noble metal mesh from being irreversibly deformed between two rollers during the knitting process.

It may likewise be advantageous for the support mesh to be knitted only up to the nearest knitted fabric take-up device; in other words, even in the case of a plurality of knitted fabric take-up devices, the support mesh can initially only be knitted over the minimum length D.

In flatbed knitting machines comprising a static knitted fabric take-up device at a distance D2 from the at least one needle bed and a movable auxiliary take-up device, a portion of the knitted fabric of length D is typically first knitted until the fabric can be tensioned by the auxiliary take-up device. As the knitting process continues, the auxiliary take-up device moves, along with the increasing length of the knitted fabric, in the direction of the static knitted fabric take-up device up to the distance D2. This carries the resulting knitted fabric along.

Within the context of the invention, a knitted fabric take-up device, in particular at distance D and/or at distance D2, exerts a pulling force on the knitted fabric, in particular on the support mesh, the noble metal mesh or both.

For knitting noble metal meshes, a minimum pulling force is preferably required. The pulling force exerted by the first, second, or both knitted fabric take-up devices, in particular by at least one roller or at least one cylinder, on the knitted fabric, in particular containing the noble metal mesh, can preferably be at least 5 N/m, in particular at least 10 N/m, and most preferably at least 15 N/m. Preferably, this minimal pulling force ensures that the knitted fabric does not jam.

The pulling force exerted on the knitted fabric by the first, second, or both knitted fabric take-up devices, in particular by at least one roller or at least one cylinder, can preferably be at most 350 N/m, in particular at most 250 N/m, and most preferably at most 150 N/m. This allows particularly high-quality noble metal meshes to be produced. For example, the maximum pulling force specified can prevent the noble metal mesh from tearing during knitting.

The pulling force can be adjusted at the knitted fabric take-up device by a person skilled in the art.

The support mesh can be knitted in one layer or in multiple layers; it can be knitted on only one needle bed or, in the case that the flatbed knitting machine comprises more than one needle bed, on multiple needle beds. The support mesh may have different regions that are single-layered and/or double-layered.

In the case that the flatbed knitting machine comprises two needle beds, the support mesh can be knitted with connecting stitches from both needle beds. The term “connecting stitches” is understood to mean the knit stitches that are formed between the first and the second needle bed. In other words, the support mesh is at least partially knitted in a single layer.

The support mesh can be knitted over the entire width or only over a portion of the width of at least one needle bed. The shape of the support mesh, in particular the first portion of the support mesh with the minimum length D, is not otherwise restricted; it may, for example, be rectangular, round or triangular. Combinations of these shapes are also possible, in particular if the support mesh comprises several regions.

The method according to the invention comprises providing at least one noble-metal-containing wire.

A noble-metal-containing wire is understood to mean a wire which consists of at least one noble metal or contains a significant proportion (>50 wt. %) of noble metal. In the context of the present invention, noble metals are understood to mean a metal selected from the group consisting of platinum metals, gold and silver. Platinum metals are understood to mean the metals of the so-called platinum group, i.e., platinum (Pt), palladium (Pd), iridium (Ir), rhodium (Rh), osmium (Os) and ruthenium (Ru).

The at least one noble-metal-containing wire preferably consists of platinum, a platinum alloy, palladium, or a palladium alloy. A platinum alloy contains more than 50 wt. % platinum, and other alloy components include in particular palladium, rhodium and ruthenium. A palladium alloy contains more than 50 wt. % palladium, and other alloy components include in particular platinum, rhodium and ruthenium.

Preferably, the at least one noble-metal-containing wire consists of an alloy selected from the group consisting of platinum with 1-15 wt. % rhodium, platinum with 1-15 wt. % rhodium and 0.1-20 wt. % palladium, platinum with 1-15 wt. % rhodium, 0.1-20 wt. % palladium and 0.1-5 wt. % ruthenium, platinum with 1-15 wt. % rhodium, 0.1-40 wt. % palladium and 0.001-5 wt. % iridium, platinum with 1-15 wt. % rhodium, 0.1-20 wt. % palladium and 0.001-5 wt. % tantalum, platinum with 1-15 wt. % rhodium, 0.001-5 wt. % iridium and 0.001-5 wt. % tantalum, palladium with 1-25 wt. % platinum, palladium with 1-25 wt. % platinum and 1-15 wt. % rhodium, palladium with 1-25 wt. % tungsten, palladium with 1-15 wt. % nickel, palladium with 0.001-5 wt. % rhodium, palladium with 1-15 wt. % copper, palladium with 1-15 wt. % copper and 1-15 wt. % nickel, and palladium with 1-30 wt. % cobalt.

Preferably, noble-metal-containing wires that have a diameter of 40-150 μm, preferably 50-130 μm, are used.

The at least one noble-metal-containing wire can be designed as a round wire, i.e., having a round cross section. In another embodiment, the wire can be designed as a flattened round wire or as a wire having a different cross section.

The at least one noble-metal-containing wire can comprise a plurality of wires, in this case also referred to as filaments, which can preferably be twisted together. The filaments can all consist of the same material, i.e., all containing noble metal, or consist of different materials, which in turn do not have to all contain noble metal.

The method according to the invention comprises knitting the noble metal mesh using the at least one noble-metal-containing wire.

According to the invention, the noble metal mesh is knitted after at least a first portion of the support mesh has been knitted; in other words, the knitted fabric is knitted at least to a length of the distance D before the noble-metal-containing wire is knitted. The noble metal mesh can be knitted over the same width of at least one needle bed as the first portion of the support mesh, but it can also be knitted narrower or wider than the first region of the support mesh.

In many cases, it can be advantageous to knit two or more noble-metal-containing wires together. In other words, during the formation of a stitch, multiple noble-metal-containing wires can be guided together such that they are knitted in parallel. In one embodiment, when knitting is carried out with a plurality of noble-metal-containing wires, the noble-metal-containing wires consist of the same material, and in further embodiments noble-metal-containing wires consisting of at least two different materials can be used. The plurality of wires may be the same or different, in particular they may have the same or different diameters and/or the same or different compositions.

The noble metal mesh can be knitted with one or two layers; in other words, the noble metal mesh can be knitted as a single-bed or double-bed fabric. The first and the second layer of the two-layer noble metal mesh can preferably be knitted from a noble-metal-containing wire or noble-metal-containing wires of the same composition. However, the two layers can also be knitted from a noble-metal-containing wire or noble-metal-containing wires of different compositions. Noble-metal-containing wire having the same or different diameters can be used to knit the first and second layers of a two-layer noble metal mesh.

The first and the second layer of a two-layer noble metal mesh can be knitted in the same or different knitting patterns. Different knitting patterns result from different stitch lengths, stitch connections, floats, or tucks, for example. In preferred embodiments, the first and the second layer of a two-layer noble metal mesh are knitted in the same knitting pattern.

The first and the second layer of a two-layer noble metal mesh can have the same or different lengths in the knitting direction and/or the same or different widths perpendicular to the knitting direction. Preferably, the first and second layers of a two-layer noble metal mesh have the same length and the same width; in other words, the first and second layers of a two-layer noble metal mesh are preferably congruent.

The first and the second layer of a two-layer noble metal mesh can have the same shape or different shapes. The first and the second layer of a two-layer noble metal mesh particularly preferably have the same shape. It may be advantageous for the first and the second layer of a two-layer noble metal mesh to have the shape of a half-ellipse, in particular the shape of a semicircle. It can be particularly advantageous for these two half-ellipses or semicircles to have the same width and the same length.

When knitting is carried out on several needle beds, it can also be advantageous to knit several noble-metal-containing wires that are not knitted in parallel and are, for example, guided between the needle beds, inserted into the resulting knitted fabric, or used to form connections between the layers.

The noble-metal-free support thread can be knitted in parallel with the at least one noble-metal-containing wire, i.e., during knitting, stitches, tucks or floats can be formed that comprise noble-metal-containing wire and noble-metal-free support thread. In these cases, the relevant portion of the resulting knitted fabric contains both noble-metal-containing wire and the material of the support thread.

The support mesh may only comprise a portion which is knitted with a minimum length D before the noble metal mesh is knitted. The support mesh may also comprise additional regions or portions. For example, it may comprise the first region of minimum length D, which is knitted before the noble metal mesh is knitted, and at least one further region, which is knitted simultaneously with the noble metal mesh, i.e. which is knitted in the same knitting rows as the noble metal mesh. The support mesh may also comprise a region that is knitted during and/or after the noble metal mesh is knitted. Accordingly, the support mesh may entirely or partially surround the noble metal mesh. The different regions of the support mesh can be connected to the noble metal mesh; however, it may be advantageous if the different regions are not connected or are only partially connected to each other.

In preferred embodiments, a first region of minimum length D may first be knitted, followed by a first noble metal mesh, and subsequently a further support mesh region and a further noble metal mesh. In other words, several noble metal meshes can be knitted, separated from each other by at least one support mesh region.

In preferred embodiments, the support mesh surrounds the noble metal mesh by at least 50%. This means that at least 50%, preferably at least 60%, even more preferably at least 80%, of the periphery of the two layers of the two-layer noble metal mesh is surrounded by the support mesh. It may be particularly preferred for the support mesh to fully surround the noble metal mesh.

The knitted fabric may therefore have knitting rows comprising noble-metal-containing wire and noble-metal-free support thread, wherein the noble metal-containing wire and the noble-metal-free support thread can be knitted fully or partially in parallel or can also be knitted fully or partially simultaneously. Such knitting rows may have regions that do not comprise any noble-metal-containing wire. Regions that do not comprise a noble-metal-containing wire may be connected to regions that comprise a noble-metal-containing wire via stitches or tucks formed by the noble-metal-containing wire and/or the noble-metal-free support thread; however, the regions may also remain unconnected. In other words, the regions of the noble metal mesh can have connections with the regions of the support mesh within a knitting row. Consecutive knitting rows can consistently include such a connection or omit such a connection; any combination thereof is also possible. For example, consecutive knitting rows may alternately include such connections; alternatively, multiple consecutive knitting rows may also include no connection, followed by one or more knitting rows with a connection. The noble metal mesh can therefore be fully or partially connected, on at least one side, to the corresponding regions of the support mesh. In the case of a partial connection, this can occur across over single or multiple consecutive knitting rows.

It may be preferable for the support mesh to be knitted in two layers in the regions comprising knitting rows that do not contain noble-metal-containing wire, if the flatbed knitting machine comprises two needle beds. In other words, the support mesh in these knitting rows cannot be knitted with connecting stitches between the first and second needle bed. These two layers can be connected at the edge stitches via connecting knit stitches; it can therefore be advantageous for the support mesh to have a tubular structure in these regions. It may also be preferable for the support mesh to be knitted in one single layer in the regions that do not comprise noble-metal-containing wire. In preferred embodiments, the support mesh comprises single-layer knitted regions and two-layer knitted regions that do not comprise noble-metal-containing wire.

Preferably, all regions of the support mesh can be knitted from noble-metal-free support threads of the same composition. However, different regions can also be knitted from noble-metal-free support threads of different compositions. Different regions of the support mesh can be knitted in the same or different knitting patterns.

The method according to the invention may comprise further steps.

The method may comprise providing at least one further wire or thread. Suitable further wires or threads can be selected depending on the intended use and/or function in the manufacturing process or for the subsequent application of the noble metal mesh. For example, the further wire can be a wire made of a non-noble metal that is suitable for stabilizing the noble metal mesh when used in the reactor, for example a steel or stainless steel wire. In these cases, the method comprises simultaneously knitting regions of the knitted fabric using the at least one further wire or thread. In this case, the knitted fabric can comprise parts or regions that contain only the further wire or thread, or portions or regions that contain both the further wire or thread and the noble-metal-containing wire, or portions or regions that contain both the further wire or thread and the noble-metal-free support thread, or portions or regions that contain both the further wire or thread and the noble-metal-containing wire and the noble-metal-free support thread.

Preferably, the support mesh can be removed in a further step. Suitable processes are in principle known to a person skilled in the art and depend on the type of noble-metal-free support thread and noble-metal-containing wire used. The support mesh can, for example, be decomposed, dissolved, melted, flamed or cut off.

The invention is explained in more detail below with reference to drawings and exemplary embodiments. However, it is not limited to these embodiments.

To determine the pulling force within the scope of the invention, the following procedure was used:

First, support meshes, e.g., a cotton mesh, were knitted on a flatbed knitting machine, with a pocket for an insertion rod being knitted into each support mesh. Insertion rods were pushed into the knitted pockets. Free-hanging weights of varying weights were attached to the insertion rods.

Next, noble metal meshes (wire: PtRh5, d=76 μm) with a knitted fabric width of one meter were knitted, each of which was subjected to a continuous pulling force by an attached weight.

The knitting result of the noble metal meshes was assessed visually. Good results were observed when there was no material jam (back-up of the knitted fabric at the needle bed) and no tears in the noble metal mesh.

The value for the pulling force (N/m) indicated in the present application is the applied pulling force divided by the knitted fabric width at the needle bed.

| | Pulling force (N/m) | Comment | | Result |
|---|---|---|---|---|
| 1 | 2 | (Own weight of the insertion rod) | | − |
| 2 | 12 | 1 | kg | ++ |
| 3 | 82 | 8 | kg | ++ |
| 4 | 162 | 16 | kg | + |
| 5 | 322 | 32 | kg | ∘ |

The pulling force always takes into account the own weight of the insertion rod.

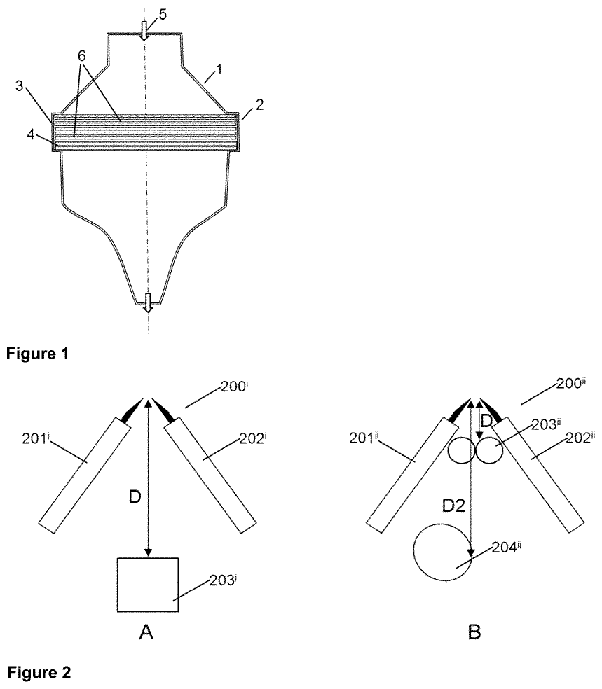

FIG. 1 is a schematic view of a flow reactor for the heterogeneous catalytic combustion of ammonia.

FIG. 2 shows partial sections perpendicular to the machine longitudinal axis of a flatbed knitting machine comprising at least one take-up device.

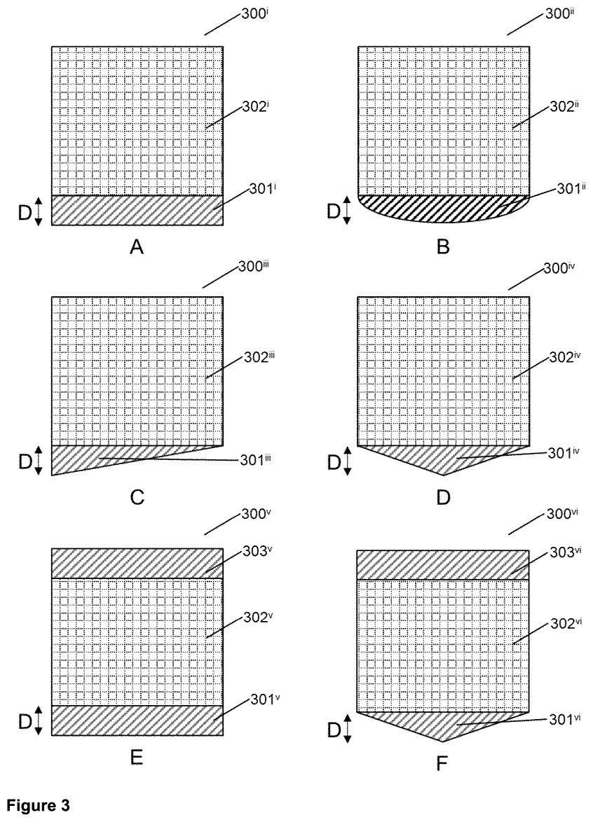

FIG. 3 shows examples of knitted fabrics with differently shaped support meshes that can be produced according to the invention.

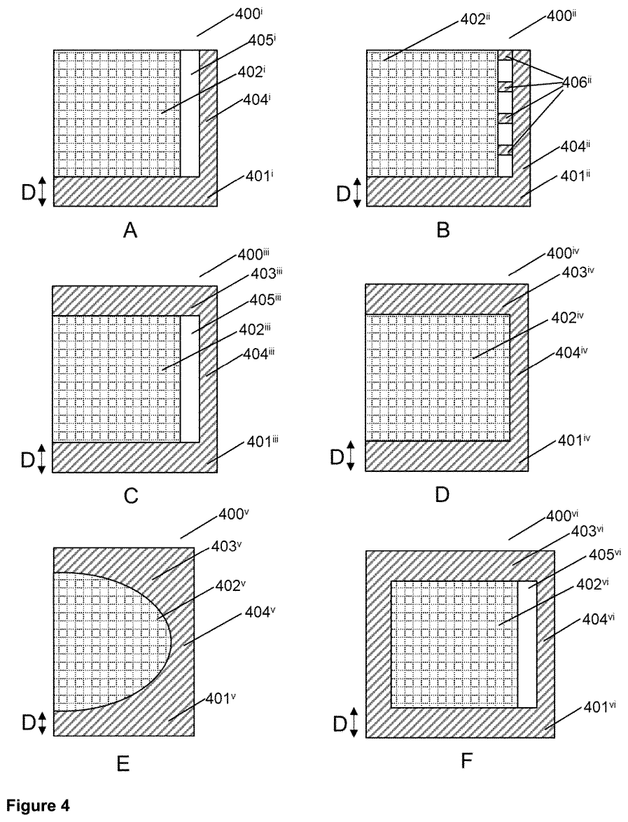

FIG. 4 shows examples of knitted fabrics that can be produced according to the invention with differently shaped support meshes that also laterally surround the noble metal mesh.

FIG. 1 is a schematic view of a vertically-positioned flow reactor 1 for the heterogeneous catalytic combustion of ammonia. The catalyst system 2 forms the actual reaction zone of the flow reactor 1. It comprises catalyst packing 3 and downstream catchment meshes 4. The catalyst packing 3 comprises a plurality of catalyst meshes 6 arranged one behind the other in the flow direction 5 of the fresh gas.

Typically, the catalyst meshes 6 are knitted meshes that are produced, for example, from various platinum-rhodium alloys by knitting wire with a diameter of 76 μm. Catchment meshes 4 may also be provided.

FIG. 2 shows partial sections perpendicular to the machine longitudinal axis of flatbed knitting machines 200, each with two needle beds 201 and 202. The flatbed knitting machine 200′ in FIG. 2 A comprises a take-up device 203′ at a distance D to the needle beds 201′ and 202′. The device 200 shown in FIG. 2 Bⁱⁱ comprises two take-up devices 203ⁱⁱ and 204ⁱⁱ at distances D and D2 to the needle beds 201ⁱⁱ and 202ⁱⁱ. The take-up device 203ⁱⁱ is shown here as comprising two cylinders between which the resulting knitted fabric can be guided, but it can also be any other take-up device known to a person skilled in the art. The same applies to the take-up apparatus 204ⁱⁱ, which is represented as a single cylinder.

FIG. 3 shows examples of knitted fabrics 300 that can be produced according to the invention with rectangular-shaped noble metal meshes 302 having differently shaped support meshes 301. In all of FIG. 3 A to F, the support meshes adjoin, across the entire width, regions of the knitted fabric 302 that were knitted from noble-metal-containing wire. The support meshes in FIG. 3 A to D each have only a first region (301′-301′^{v}) of length D, which is differently shaped. In FIGS. E and F, the support meshes also have a second region (303^{v}, 303^{vi}) which is arranged in the knitted fabric above the noble-metal-containing region (302^{v},302^{vi}).

FIG. 4 shows examples of knitted fabrics 400 that can be produced according to the invention with differently shaped support meshes which also laterally surround the noble metal mesh. The first region of length D (401ⁱ-401^{vi}) has an at least partially rectangular shape, but all other shapes are also possible. In FIG. 4 A, the support mesh comprises a second region 404ⁱ, which laterally surrounds the noble-metal-containing knitted fabric region 402ⁱ. In the embodiment shown, there is no connection between the noble-metal-containing region 402ⁱ and support mesh region 404ⁱ; the knitted fabric has a gap 405ⁱ. In the embodiment shown in FIG. 4 B, the lateral support mesh region 404ⁱⁱ is partially connected with the noble-metal-containing region 402ⁱⁱ (406ⁱⁱ). The embodiment of the support mesh shown in FIG. 4 C has a further region 403ⁱⁱⁱ above the noble-metal-containing region 402ⁱⁱⁱ. FIG. 4 D shows a support mesh that surrounds the noble-metal-containing region 402^{iv} on three sides (401^{iv}, 403^{iv}, 404^{iv}) and is fully connected to it. FIG. 4 E also shows such an embodiment, but the noble-metal-containing knitted region 402^{v} is semicircular in shape. In FIG. 4 F, the support mesh fully surrounds the noble-metal-containing knitted fabric 402^{vi}, with no connection at one side between the adjoining abutting edges (405^{vi}).

Combinations of the different embodiments, which are shown as examples in FIGS. 3 and 4, are also conceivable. The different regions of the support meshes may each be configured as single-layered or double-layered; any combination is also possible.

### DEFINITION OF THE REFERENCE SIGNS USED

1 Flow reactor
2 Catalyst system
3 Catalyst packing
4 Catchment meshes
5 Flow direction
6 Catalyst meshes
200 Flatbed knitting machine
201 First needle bed
202 Second needle bed
203 Take-up device
204 Take-up device
300, 400 Knitted fabric
301, 401 First support mesh region
302, 402 Noble metal mesh
303, 304 Additional support mesh region
404 Lateral support mesh region
405 Gap between noble metal mesh and support mesh
406 Connections between noble metal mesh and support mesh

1. A method for producing a noble metal mesh on a flatbed knitting machine, wherein the flatbed knitting machine comprises at least one needle bed and at least one knitted fabric take-up device spaced apart at a distance D from the at least one needle bed,
comprising the steps
providing at least one noble-metal-free support thread,
providing at least one noble-metal-containing wire,
knitting a support mesh using the at least one noble-metal-free support thread,
knitting the noble metal mesh using the at least one noble-metal-containing wire, wherein at least a portion of the support mesh is first knitted over at least the length of the distance D.

2. The method according to claim 1, wherein the at least one noble-metal-containing wire consists of platinum, a platinum alloy, palladium, or a palladium alloy.

3. The method according to claim 1, wherein the at least one noble-metal-containing wire has a diameter of 40-150 μm.

4. The method according to claim 1, wherein two or more noble-metal-containing wires are knitted in parallel.

5. The method according to claim 1, wherein the noble-metal-free support thread comprises a material selected from the group consisting of polyamides, polyesters, cellulose fibers, cotton, acrylic-styrene polymers, nylon, vinyl polymers, alginate, copper, aluminum, tin alloys, and lead alloys.

6. The method according to claim 1, wherein the flatbed knitting machine comprises a plurality of knitted fabric take-up devices.

7. The method according to claim 6, wherein at least a portion of the support mesh is first knitted over at least the length of the distance up to a knitted fabric take-up device further away than distance D.

8. The method according to claim 7, wherein the knitted fabric take-up device further away than distance D is arranged at a distance D2 and at least a portion of the support mesh is knitted over at least the length D2.

9. The method according to claim 1, wherein the support mesh comprises a plurality of regions.

10. The method according claim 1, wherein the support mesh surrounds at least 50% of the noble metal mesh.

11. The method according to claim 1, wherein the support mesh comprises a region that is knitted after the noble metal mesh is knitted.

12. The method according to claim 1, wherein the method comprises a further step in which the support mesh is removed.

13. The method according to claim 1, wherein the knitted fabric take-up device at the distance D and/or the knitted fabric take-up device at the distance D2 exerts a pulling force on the support mesh and/or the noble metal mesh, wherein the exerted pulling force is at least 5 N/m, in particular at least 10 N/m.

14. The method according to claim 1, wherein the knitted fabric take-up device comprises at least one roller or cylinder.

15. The method according to claim 2, wherein the at least one noble-metal-containing wire has a diameter of 40-150 μm.

16. The method according to claim 2, wherein two or more noble-metal-containing wires are knitted in parallel

17. The method according to claim 3, wherein two or more noble-metal-containing wires are knitted in parallel

18. The method according to claim 2, wherein the noble-metal-free support thread comprises a material selected from the group consisting of polyamides, polyesters, cellulose fibers, cotton, acrylic-styrene polymers, nylon, vinyl polymers, alginate, copper, aluminum, tin alloys, and lead alloys.

19. The method according to claim 3, wherein the noble-metal-free support thread comprises a material selected from the group consisting of polyamides, polyesters, cellulose fibers, cotton, acrylic-styrene polymers, nylon, vinyl polymers, alginate, copper, aluminum, tin alloys, and lead alloys.

20. The method according to claim 4, wherein the noble-metal-free support thread comprises a material selected from the group consisting of polyamides, polyesters, cellulose fibers, cotton, acrylic-styrene polymers, nylon, vinyl polymers, alginate, copper, aluminum, tin alloys, and lead alloys.
